(19) United States
(12) Patent Application Publication
(10) Pub. No.: US 2006/0103532 A1
(43) Pub. Date: May 18, 2006

(54) Electromagnetic pathways to eliminate RFID limitations

(75) Inventor: Steven Robert Van Fleet, Lagrangeville, NY (US)

Correspondence Address: INTERNATIONAL PAPER COMPANY, 6285 TRI-RIDGE BOULEVARD, LOVELAND, OH, 45140, US

(73) Assignee: International Paper Company, Stamford, CT (US)

(21) Appl. No.: 10/987,652

(22) Filed: Nov. 12, 2004

(51) Int. Cl. G08B 13/14

(52) U.S. Cl. 340/572.1

(57) ABSTRACT

A system for enhanced substantially simultaneously monitoring multiple aggregated RFID-tagged products comprising an RFID reader disposed remote from said aggregated RFID-tagged products and a supplemental antenna disposed intermediate the RFID reader and the RFID-tagged products. The supplemental antenna includes at least a portion thereof in substantially non-interrupted communication with multiple ones of the RFID tags associated with the RFID-tagged products and at least a portion thereof being in substantially non-interrupted communication with said antenna associated with said RFID reader, whereby said supplemental antenna enhances the transmission of coded information between the reader and the RFID tags associated with the RFID tagged products. A slip sheet having a supplemental antennas associated therewith is disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to electromagnetic identification of tagging of merchandise employing radio frequencies.

More particularly, this invention pertains to a method and apparatus for improving the transmissions of electromagnetic (particularly radio frequency) radiation between an RFID reader and a remote product having an RFID tag associated therewith.

2. Description of the Related Art

Current practices in inventory management are increasingly employing Radio Frequency Identification (RFID) tags to monitor the progress of merchandise as the individual items or packages move through the supply chain from the manufacturer to the wholesaler to the retailer shelves and/or even to the end user. In this monitoring system, each item or package of merchandise is provided with an RFID tag which is capable of electronically storing various information such as the identity, quantity, etc. of the item and/or its contents, origination source, and substantial other information deemed to be useful in monitoring the movement of the item through the channels of commerce and/or ultimate disposition of the item.

Radio frequencies (RF) are subject to distortion, reflection, weakening, and other adverse effects by such materials as liquids and/or metals, and other environmental effects such as the distance of travel of the RF signal and the presence or absence of RF-blocking or distortion materials between the source of the RF and the receiver thereof (RFID reader, for example).

In commerce, it is common to stack products or cartons containing products on pallets for storage or shipping, for example. If the carton is tagged with an RFID tag, by scanning the individual carton or a plurality of cartons on a single pallet with an RFID reader, the identity and number of items contained within the carton or the identity of the cartons in the stack are ascertainable.

However, the known limitations on this activity by reason of the presence in the field of the RF of certain materials which hinder the transmission of the signal, for example, strongly adversely affect the accuracy of the detection and reading of RFID tags associated with individual items of merchandise or individual items or clusters of individual items with RFID tags on them. When packages or containers containing liquids or metals are clustered in a typical shipping pallet configuration or on a retail shelf, then the RFID reader may not recognize all of the RFID tags. This will result in a miscount, essentially destroying the value of the inventory controls. This problem of “invisible” RFID tags is particularly troublesome where the individual packages of product are oriented such that the RFID tag is not “visible” to the RFID reader. This situation may occur due to the orientation of cases of product stacked on a pallet, and especially may occur when individual packages of products are disposed on a retail display shelf in side-by-side relationship. That is, on retail display shelves, space is at a premium and retailers tend to arrange packages of like products in abutting relationship to one another, an action which frequently hides the RFID tag from an RFID reader. This problem is compounded when the product container in the package, or the package itself, includes a liquid or metal material. Cigarette packages which may include metallized foil is one example.

The current EPC standard for RFIDs and their readers are 13.56 MHz and 915 MHz. Both of these frequencies are impacted by the presence of liquids and metals. The inability to read all the RFID tags on packages on a shipping pallet significantly reduces the business value proposition or cost justification for implementing RFID technology in the supply chain. For example, if a shpper must break down a pallet containing 80-120 shipping cases in order to read the RFID tag on each case, then there is no value proposition. Current RFID reader configurations, i.e. dock door portals, stationary readers and hand held readers, cannot read all the RFID tags in a pallet configuration when the products or packaging contain liquids and/or metals. Typically such reader configurations can read those tags that are found on the outer surfaces of the pallet configuration and some of the tags that have a clear read pathway, i.e., no liquids or metals between the reader and the RFID tag.

Compounding the problem of accessibility to the cartons/packages by RF radiation is the cost of the tags themselves. To make a tag which has greater “broadcasting strength” is materially more expensive than making a tag which has a limited broadcast strength. Thus, increasing the broadcasting strength of the chip in the RFID, to date, has not been an acceptable option.

### SUMMARY OF INVENTION

In accordance with one aspect of the present invention, the present inventor provides an inhanced pathway from a remote RFID reader to a plurality of target tags associated with single or multiple packages, cartons or cases of packaged or unpackaged merchandise, in the form of a supplemental antenna interposed between a location operatively adjacent one or more of individual cases or packages of products which are disposed in stacked or palletized configuration, for example. This supplemental antenna provides for substantially uninterrupted transmission of RFID signals between an RFID reader and an RFID tag irrespective of the presence of RFID-transmission barriers associated with closely stocked or aggregated RFID tag-bearing cases, cartons or other packaging of products. It further alleviates RF transmission problems due to the process of water, other liquids and/or metal which may be contained in the clustered packages or otherwise interposed between the RFID tag and the reader. In a preferred embodiment, the present invention includes a slip sheet having a plurality of spaced apart supplemental antennas associated therewith, each supplemental antennae being adapted to transmit RF signals to and from a remote RFID reader (having an antennae associated therewith) and a plurality of RFID tags associated with groupings of merchandise, for example.

### BRIEF DESCRIPTION OF THE FIGURES

FIG. 1 is a schematic representation of a system depicting the reading of the RFID tags on adjacent packages of cigarettes on a retail shelf;

FIG. 2 is a schematic representation of tagged merchandise disposed on a retail (or other storage) shelf for tagged merchandise and including a supplemental antenna of the present invention associated with each such item of merchandise;

FIG. 3, is a schematic representation of a conventional slip sheet employed in palletized cases of product and depicting supplemental antennas carried by the slip sheet;

FIG. 4, is a schematic representation of a system for reading the tags associated with a palletized grouping of multiple tagged cases of merchandise and depicting slip sheets of the present invention interposed between layers of the cases;

FIG. 5 is a schematic representation of the system depicted in FIG. 4 wherein the side edges of the slip sheets are folded upward out of the plane of the slip sheet for more ready accessibility of the RF from an RFID reader to the tags on the tagged cases; and,

FIG. 6 is a schematic representation of an embodiment of a laminated slip sheet having multiple antennas disposed between top and bottom layers of paper material.

### DETAILED DESCRIPTION OF INVENTION

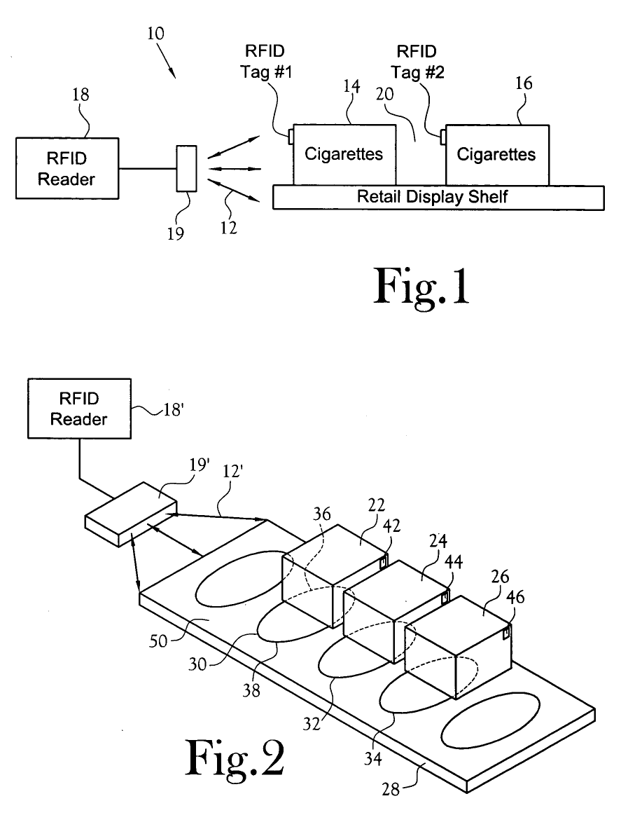

In FIG. 1, there is depicted a system 10 for the common application of the use of RF signals 12 as a medium for recognizing multiple containers of merchandise stacked on a retail shelf, for example, employing a remote RFID reader 18. In this Figure, there are depicted two RFID-tagged cartons 14 and 16 of cigarettes (known to container metallized foil), the two cartons being aligned with one of the cartons 14 disposed between the other 16 of the cartons and a remote RFID reader 18 having an antenna associated therewith. In this situation, the RFID tag #2 of the second carton will likely not be recognized by the reader due to the metallized foil in the cigarette packages of the first carton 14 blocking or distorting the RF from the reader. In this situation, if the RFID tags are associated with the individual cartons of cigarettes, the reader will consistently recognize RFID tag #1 associated with the first carton 14, but will recognize RFID tag #2 only when there is an air gap 20% greater than about one inch between the cartons. This same result has been observed when the cartons of cigarettes are palletized. That is, the RFID tags associated with those cartons most “inner” of the pallet are not recognized by the RFID reader.

In FIG. 2, there are depicted three cartons 22, 24 and 26 of cigarettes disposed on a retail display shelf 28 in side-by-side relationship. In accordance with one aspect of the present invention, the shelf is provided with an elliptical supplemental antenna 30, 32 and 34 respectively, associated with each individual and/or row of cartons on the shelf. In this embodiment, each of the shelf antennas include a portion 36 thereof which is disposed directly beneath one of the cartons 22 on the shelf and a second portion 38 which projects out from under the same carton, whereby such second portion of the antenna is exposed for substantially uninterrupted access by RF generated signals 12 by a remote RFID reader 18, and its associated antennae 19. In this embodiment, the RF signals 12 emanating from the antenna 19 associated with the RFID reader 18 readily reach, and are picked up by, each of the supplemental antennas associated with the shelf and are transmitted to one or more tags 42, 44 and 46 which are associated with the cartons of cigarettes. Reverse transmission of RF from the tags to the reader takes place in like manner. The use of supplemental antennae associated with products stored on a shelf provide the advantage that the usual microchip in the RFID tag can be smaller, without a chip antennae, and less power consuming hence, having less expensive. This advantage is directly related to the near proximity of the supplemental antennae to the RFID tag. Further, in this embodiment, the RF signal from the antennae 19; in combination with the supplement antennae 20, 22 and 24, can access tags on individual packages of cigarettes within a carton.

In the embodiment depicted in FIG. 2, each of the antenna on the shelf may comprise an individual antenna associated with each of the cartons on the shelf or may be of a size and geometry sufficient to accommodate multiple ones of the cartons on the shelf. Further, each antenna may be applied (releasably or fixedly) to the top surface 50 of the shelf by any of several conventional means. In one embodiment, the multiple antennas may be affixed to a strip of material, such as a strip of paper or paperboard or the like, and the strip itself may be applied to the top surface of the shelf.

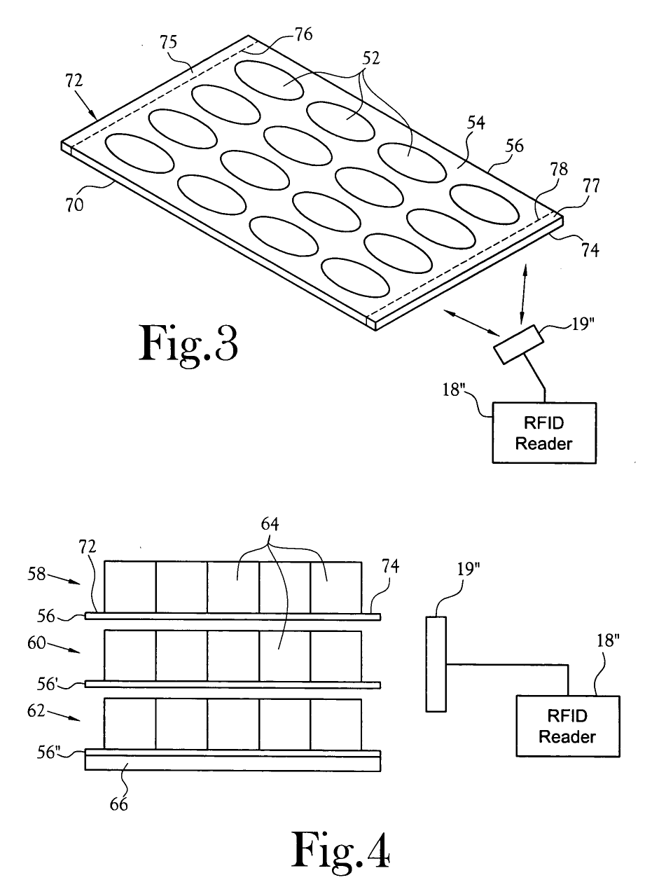

In the embodiment of the present invention depicted in FIGS. 3 and 4, there is provided a plurality of individual antennas 52 (typical) affixed to one surface 54 of a conventional paper slip sheet 56. Individual ones 56, 56′ and 56″ of the antenna-bearing slip sheets are designed to be inserted between rows 58, 60 and 62 of cases 64% product stacked on a pallet 66, for example, as depicted in FIG. 4 and/or between the bottom row 62 of cases and the pallet 66 itself.

Each slip sheet 56, for example, itself may be formed from any material which does not materially interfere with the transmission of RF signals and which provides the normal function of a slip sheet. Preferably the slip sheet material is transparent to RF signals, such as is corrugated paperboard. By this means, RF signals may be transmitted bidirectionally between a reader 18″ and its antenna 19″ and each of the supplemental antennas 52 and also bidirectionally between the supplemental antennas and those cases in the row above the slip sheet and those cases in the row below the slip sheet. Paper sheet material having a basis weight of between about 40 and about 200 per 3000 ft² is commonly employed as slip sheet material. Desirably, the slip sheet material contributes minimally to the cost of the completed slip sheet in that slip sheets commonly are not recycled as slip sheets. However, depending upon the durability of the slip sheet material, if desired, the antennae-bearing slip sheets may be recycled.

Fixation of the antennas 52 to the top surface 54 of the slip sheet 56 may be by any conventional means for affixing antennas to planar materials. In addition to glue-type affixation of the antennas to the slip sheet, the antennae may be printed on or embossed into the slip sheet, embedded in the slip sheet, plasticized or other wise fixed in their spaced apart locations over the top surface of the slip sheet. Through choice of the size and geometry of the multiple antennas 52, the present inventors may selectively provide suitable antennas for any of a large variety of shapes and sizes of cases, cartons, etc. on the pallet.

Whereas the slip sheet depicted in FIG. 3 includes supplemental antennas 52 on only the top surface of the slip sheet, it will be understood that supplemental antennas may be affixed also to the bottom surface 70 of the slip sheet. In such event, the material of the slip sheet will not be transparent to RF signals.

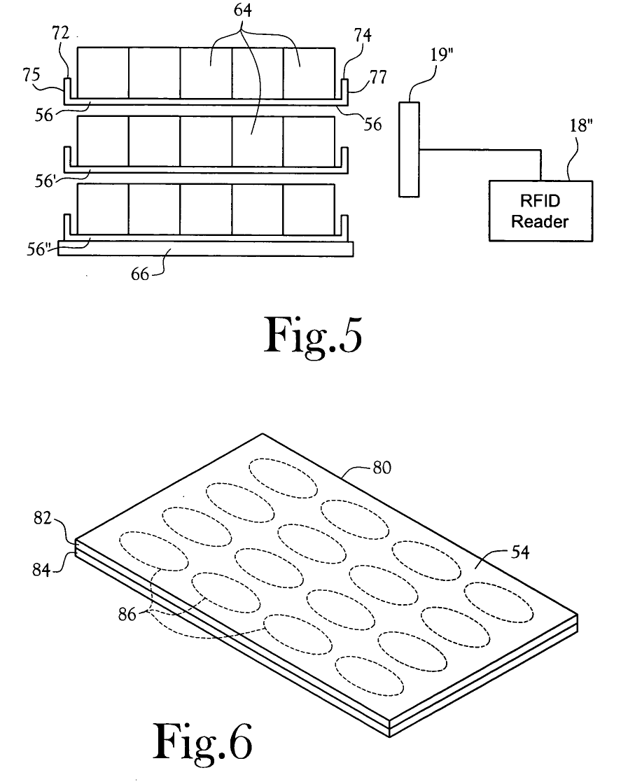

In one embodiment of an antenna-bearing slip sheet 56 of the present invention, as shown in FIGS. 3 and 5, the slip sheet is wider in at least one dimension than the anticipated stack of cases on the pallet so that when the slip sheet is disposed between adjacent rows of cases on the pallet, short portions 75 and 77 of the opposite ends 72 and 74, respectively, of the slip sheet project beyond the outer ones of the cases on the pallet. In this embodiment, the inventor provides a perforations or score (fold) line 76 and 78 inwardly of at least two opposite ones of those side edges 72 which project laterally beyond the stacked cases on the pallet. This perforation or score line is disposed inwardly from respective ones of these projecting side edges by a distance substantially equal to the length of each overhang. Thereby, each such side edge may be folded upwardly or downwardly to provide more ready accessibility of RF signals from the reader to the supplemental antennas disposed on the slip sheet interiorly of the palletized cases. Any of the four opposite side edges of the slip sheet may be provided with perforations or score lines, as desired, thereby eliminating directionality of application of the slip sheet between the rows of the cases. That is, one can choose which ones of the opposite sides of the slip sheet are up or down folded to accommodate the known orientation of the pallet at the time it is being exposed to the RF signals, such as when the pallet is passing through a fixed reader apparatus.

In a further embodiment of the present invention, as depicted in FIG. 6, the slip sheet may comprise a lamination 80 which includes a outer top layer 82, an outer bottom layer 84 and either a plurality of supplemental antennas 86 disposed between such outer top and bottom layers, or a plurality of antennas disposed on a third inner layer. As noted above, each of the outer layers, and any intermediate layer, is transparent to RF signals, thereby permitting RF transmission to take place between the supplemental antennas disposed internally of the laminate and a reader and tags associated with the cases on the pallet. One embodiment includes lamination onto a corrugated paperboard substrate. Conventional laminating apparatus and processes may be employed in the formation of a laminate as depicted in FIG. 6.

In accordance with one aspect of the present invention, the ability to create electromagnetic pathways through a palletized grouping of RFID-tagged products opens up the opportunity of eliminating those current limitations of the 915 MHz frequency togs which are associated with the physics of systems currently in use.

Further, as desired or used, the slip sheet may be seamed or perforated to provide visibility of the electromagnetic pathway to the readers.

Whereas the present invention has been described employing specific examples, it is intended that the invention be limited only as set forth in the claims appended hereto. Moreover, whereas the permanent slip sheets may not provide for identification of 100% of the RFID tags in an aggregation of tagged products, the present invention has repeatedly demonstrated identification of ninety-plus percent of palletized tagged products which have liquid or metal materials associated therewith.

What is claimed:

1. A system for enhanced substantially simultaneously monitoring multiple aggregated RFID-tagged products comprising an RFID reader disposed remote from said aggregated RFID-tagged products, said reader including an antenna for the transmission and reception of RF signals in the direction of said RFID-tagged products, a supplemental antenna disposed intermediate said antenna associated with said RFID reader and said RFID-tagged products, said supplemental antenna including at least a portion thereof in substantially non-interrupted RF communication with multiple ones of said RFID tags associated with said RFID-tagged products and at least a portion thereof being in substantially non-interrupted RF communication with said antenna associated with said RFID reader, whereby said supplemental antenna enhances the transmission of coded information between said reader and said RFID tags associated with said RFID tagged products.

2. The system of claim 1 wherein said RFID-tagged products are disposed in rows or layers on a pallet.

3. The system of claim 1 and including a carrier to which said supplemental antenna is mounted.

4. The system of claim 3 wherein said carrier is substantially transparent to RF signals.

5. The system of claim 3 wherein said RFID-tagged products are disposed in layers or multiple adjacent containers and said carrier comprises a slip sheet having at least one supplemental antenna associated therewith and disposed in RF frequency transmission relationship to said RFID-tagged products.

6. The system of claim 1 and including RF signal interrupters interposed between said at least one antenna associated with said reader and said RFID-tagged products.

7. The system of claim 1 and including a multiplicity of supplemental antennas disposed between said antenna associated with said RFID reader and said RFID-tagged products.

8. The system of claim 2 wherein said supplemental antennas are associated with a slip sheet disposed between rows layers or groupings of said RFID-tagged products.

9. The system of claim 8 wherein said slip sheet comprises a paper material.

10. The system of claim 8 wherein said slip sheet is dimensionally greater in at least one side-to-side direction than said aggregated RFID-tagged products on said pallet and at least one side edge of said slip sheet is provided with means for enhancing the folding of said at least one side edge in a direction toward or away from said pallet.

11. A slip sheet for enhancing the transmission of RF signals between a first antenna associated with a remote RFID reader and multiple RFID tags associated with RFID-tagged products disposed in an aggregated relationship to one another comprising a planar member having affixed thereon at least one antenna suitable for the receipt and transmission of RF signals and disposed between said first antenna and said RFID-tagged products.

12. The slip sheet of claim 11 wherein said planar member comprises a paper material.

13. The slip sheet of claim 11 wherein said planar member comprises a first surface and a plurality of said at least one antenna affixed in spaced apart locations on said first surface.

14. The slip sheet of claim 13 wherein said plurality of at least one antenna comprises an elongated loop having first and second legs, said first leg being disposed in RF-transmission relationship to said at least one of said RFID-tagged products and in RF-transmission relationship to an antenna associated with said RFID reader.

15. The slip sheet of claim 11 and including a further planar member overlaid over said planar member with said at least one antenna being interposed in layered relationship with and between said planar member and said further planar member.

16. The slip sheet of claim 11 wherein said at least one antenna is associated with said slip sheet by either gluing, embossing, embedding, plasticizing, or printing.
